(19) United States
(12) Patent Application Publication
(10) Pub. No.: US 2007/0037952 A1
(43) Pub. Date: Feb. 15, 2007

(54) Method for the production of mixtures for the production of polyurethane

(75) Inventors: Jan-Michael Dreisoerner, Huellhorst (DE); Hartmut Giesker, Bissendorf (DE); Johann Knake, Drebber (DE); Maria Thomas, Muehlen (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/571,773

(22) PCT Filed: Sep. 18, 2004
(86) PCT No.: PCT/EP04/10496

§ 371 Date: Mar. 15, 2006

(30) Foreign Application Priority Data
Sep. 26, 2003 (DE) 10345099.8

(51) Int. Cl. C08G 18/00

(52) U.S. Cl. 528/44

(57) ABSTRACT

The invention relates to a process for the admixture of additives to structural polyurethane components, which comprises continuously feeding the additives and the structural polyurethane components to a mixing apparatus, and continuously removing the resultant mixture from the mixing apparatus.

The invention relates to a process for preparing mixtures which may be used for preparing polyurethanes.

The preparation of polyurethanes has been known for a long time, and usually takes place via reaction of polyisocyanates with compounds having at least two hydrogen atoms reactive toward isocyanate groups, these being termed structural polyurethane components below.

In order to promote the reaction between the structural polyurethane components, and also to achieve better properties in the polyurethanes, it is also necessary for catalysts, blowing agents, and also auxiliaries and/or additives, such as stabilizers, pigments, or dyes, to be added to the reaction mixture. These compounds, generally termed additives below, are mostly mixed with the compounds having at least two hydrogen atoms reactive toward isocyanate groups, to give what is known as a polyol component, and are mixed in this form with the polyisocyanates.

As mentioned, the additives comprise a large number of different substances, the addition of which to the starting compounds is a function of the desired end use of the polyurethanes, but they can have a highly disruptive effect in other applications. In these instances, the systems are described as subject to contamination. Contamination is present when the starting material for a batch impairs the product properties of a subsequent batch. Features associated with contamination may be, by way of example, cloudiness of products which are normally transparent, discoloration, an alteration of the surface structure of the polyurethanes, for example open-celled instead of compact, or discrepancies in the physical properties of the plastics, e.g. loss of hardness, alterations in elasticity, or alterations in thermal conductivity.

Industry mostly uses stirred tanks for preparing the polyol components by mixing various compounds having at least two active hydrogen atoms, mostly long-chain polyols and, if appropriate, short-chain chain extenders and/or crosslinkers, with the additives mentioned.

There is mostly only a limited number of available mixers, such as stirred tanks, in which the various mixtures are prepared. In industry this constantly causes quality problems due to incompatibility of individual additives in other polyurethanes. In order to avoid rejects and complaints, the mixing tanks are regularly cleaned in accordance with specified criteria, to minimize contamination. Cleaning operations comprise not only the mixing tank but also product lines, recirculation lines, pumps, and valves, meaning that the work required is very comprehensive and complicated. The availability of the individual tank falls significantly because of long set-up and cleaning times, the result being a need to provide and maintain many tanks with low utilization levels. Nevertheless, the problem of contamination is not eliminated.

Another problem with the addition of the additives is that these are often used in very small amounts, based on the polyurethane starting compounds. One result of this, if stirred tanks are used as mixing apparatus, is that homogeneous mixing is not achieved. This, too, can be associated with quality problems in the resultant polyurethanes.

It was an object of the invention to develop a process which prepares mixtures composed of polyurethane starting compounds and of additives, and in which the problem of contamination of the mixing apparatus is excluded, the result being good and thorough mixing of the components.

The object was achieved by continuously combining the additives in the desired mixing ratio in a mixing apparatus with the structural polyurethane components.

The invention therefore provides a process for the admixture of additives to structural polyurethane components, which comprises continuously feeding the additives and the structural polyurethane components to a mixing apparatus, and continuously removing the resultant mixture from the mixing apparatus.

A condition for the suitability of additives for the inventive process is that their consistency permits them to be subjected to continuous mixing. They must therefore be present either in liquid form or in paste form. If the additives are solids, they should be converted into a form suitable for the inventive process prior to the continuous mixing process, via solution, dispersion, or similar operations.

For the purposes of the present invention, additives are all of the starting materials which are present in the reaction mixture during the preparation of polyurethanes in addition to the polyisocyanates and to the compounds having at least two hydrogen atoms reactive toward isocyanate groups. Specifically, they are blowing agents, flame retardants, catalysts, and also auxiliaries and/or additives, such as antifoams, light stabilizers, low-temperature stabilizers, other stabilizers, emulsifiers, flow improvers, pigments, dyes.

The amount added of the catalysts, auxiliaries, and/or additives is mostly in the range from 0.001 to 5% by weight, based on the weight of the resultant polyurethane. The usual amount of blowing agents and/or flame retardants used is from 3 to 40% by weight, based on the weight of the resultant polyurethane.

Details required concerning the compounds mentioned are as follows:

Compounds used as catalysts are in particular those which markedly accelerate the reaction of the compounds containing hydroxy groups in components (b) and, if appropriate, (c) with the polyisocyanates. Use may be made of organometallic compounds, preferably organic tin compounds, for example stannous salts of organic carboxylic acids, e.g. stannous acetate, stannous octoate, stannous ethylhexoate, or stannous laurate, or the dialkyltin(IV) salts of organic carboxylic acids, e.g. dibutyltin diacetate, dibutyltin dilaurate, dibutyltin maleate, or dioctyltin diacetate. The organometallic compounds are used alone, or preferably combined with strongly basic amines. Examples which may be mentioned are amidines, such as 1,8-diazabicyclo[5.4.0]undec-7-ene, 2,3-dimethyl-3,4,5,6-tetrahydropyrimidine, tertiary amines, such as triethylamine, tributylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine, pentamethyidiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and aminoalkanol compounds, such as triethanolamine, trisopropanolamine, N-methyl- and N-ethyldiethanolamine, and dimethylethanolamine.

Other catalysts which may be used are tris(dialkylaminoalkyl)-s-hexahydrotriazines, in particular 1,3,5-tris(N, N-dimethylaminopropyl)-s-hexahydrotriazine, tetraalkylammonium hydroxides, such as tetramethylammonium hydroxide, alkali metal hydroxides, such as sodium hydroxide, and alkali metal alkoxides, such as sodium methoxide and potassium isopropoxide, and also alkali metal salts of long-chain fatty acids having from 10 to 20 carbon atoms and, if appropriate, lateral OH groups. It is preferable to use from 0.001 to 5% by weight, in particular from 0.05 to 2.5% by weight of catalyst or catalyst combination, based on the weight of component (b).

By way of example, additives which may be mentioned are surface-active substances, foam stabilizers, cell regulators, fillers, dyes, pigments, flame retardants, antistatic agents, hydrolysis stabilizers, and substances with fungistatic and bacteriostatic action.

Examples of surface-active substances which may be used are those which serve to promote homogenization of the starting materials and, if appropriate, are also suitable for regulating cell structure. Examples which may be mentioned are emulsifiers, such as the sodium salts of castor oil sulfates, or of fatty acids, and also salts of fatty acids with amines, e.g. diethylamine oleate, diethanolamine stearate, diethanolamine ricinoleate, salts of sulfonic acids, e.g. alkali metal or ammonium salts of dodecylbenzene- or dinaphthylmethanedisulfonic acid, and ricinoleic acid, foam stabilizers, such as siloxane-oxalkylene copolymers and other organopolysiloxanes, ethoxylated alkylphenols, ethoxylated fatty alcohols, paraffin oils, castor oil esters, ricinoleic acid esters, turkey red oil, and groundnut oil, and cell regulators, such as paraffins, fatty alcohols, and dimethylpolysiloxanes. For an improvement in emulsifying action, and in the cell structure, and/or stabilization of the rigid foam, oligomeric polyacrylates having polyoxyalkylene and fluoroalkane radicals as side groups are also suitable. The usual amounts used of the surface-active substances are from 0.01 to 5 parts by weight, based on 100 parts by weight of component (b).

Fillers, in particular reinforcing fillers, are the weighting agents, reinforcing agents, and fillers of conventional organic and inorganic type, these being known per se. Individual examples which may be mentioned are: inorganic fillers, e.g. silicatic minerals, for example phyllosilicates, such as antigorite, serpentine, hornblendes, amphiboles, chrysotile, talc; metal oxides, such as kaolin, aluminum oxides, aluminum silicate, titanium oxide, and iron oxides, metal salts, such as chalk, baryte, and inorganic pigments, such as cadmium sulfide, zinc sulfide, and also glass particles. Examples of inorganic fillers which may be used are: carbon black, melamine, colonylophonae, cyclopentadienyl resins, and graft polymers.

The inorganic and organic fillers may be used individually or as mixtures, their amounts incorporated into the reaction mixture advantageously being from 0.5 to 50% by weight, preferably from 1 to 40% by weight, based on the weight of components (a) to (c).

By way of example, suitable flame retardants are tricresyl phosphate, tris(2-chloroethyl) phosphate, tris(2-chloropropyl) phosphate, tris(1,3-dichloropropyl) phosphate, tris(2,3-dibromopropyl) phosphate, and tetrakis(2-chloroethyl) ethylenediphosphate.

Besides the abovementioned halogen-substituted phosphates, it is also possible to use inorganic flame retardants, such as red phosphorus, red-phosphorus preparations, aluminum oxide hydrate, antimony trioxide, arsenic oxide, ammonium polyphosphate, and calcium sulfate, or cyanuric acid derivatives, e.g. melamine, or mixtures composed of at least two flame retardants, e.g. ammonium polyphosphates and melamine, or else, if appropriate, starches, to provide flame retardancy to the rigid PU foams produced according to the invention. It has generally proven advantageous to use from 5 to 50 parts by weight, preferably from 5 to 25 parts by weight, of the flame retardants or flame retardant mixtures mentioned for each 100 parts by weight of components (a) to (c).

Further details concerning the abovementioned other conventional auxiliaries and additives may be found in the technical literature, e.g. the monograph by J. H. Saunders and K. C. Frisch “High Polymers” volume XVI, Polyurethanes, parts 1 and 2, Verlag Interscience Publishers 1962 or 1964, or Kunststoff-Handbuch, Polyurethane, volume VII, Carl-Hanser-Verlag, Munich, Vienna, 1st, 2nd and 3rd edition, 1966, 1983 and 1993.

The additives are usually added to the compounds having at least two reactive hydrogen atoms. In industry, the resultant mixture is often termed polyol component. However, it is also possible in principle to add these compounds to the polyisocyanates, a condition in the case of this process being, however, that they have no functional groups which can react with isocyanate groups.

Blowing agents which may be used are chemical blowing agents which liberate gases, in particular carbon dioxide, via reaction with the isocyanate groups. Examples of these are water and carboxylic acids. Another class of blowing agents is that of compounds which are liquid at room temperature and are inert toward the polyurethane starting components, and which vaporize under the conditions of the polyurethane reaction, these also being termed physical blowing agents.

Compounds suitable as physical blowing agents may be selected from the group of the alkanes, cycloalkanes having not more than 4 carbon atoms, dialkyl ethers, cycloalkylene ethers, and fluoroalkanes. It is also possible to use mixtures of at least two compounds from the specified groups of compounds. By way of example, individual examples which may be mentioned are: alkanes, e.g. propane, n-butane, isobutane, n-pentane, isopentane, and also industrial pentane mixtures, cycloalkanes, e.g. cyclopentane, cyclobutane, dialkyl ethers, e.g. dimethyl ether, methyl ethyl ether, methyl butyl ether, or diethyl ether, cycloalkylene ethers, e.g. furan, and fluoroalkanes, where these are degraded in the troposphere and therefore not harmful to the ozone layer, e.g. trifluoromethane, difluoromethane, difluoroethane, tetrafluoroethane, and heptafluoropropane.

The physical blowing agents may be used alone, or preferably in association with water, and combinations which have proven particularly successful are the following, these therefore being used with advantage: water and cyclopentane, water and cyclopentane or cyclohexane, or a mixture of these cycloalkanes, and at least one compound from the group n-butane, isobutane, n-pentane, isopentane, industrial pentane mixtures, cyclobutane, methyl butyl ether, diethyl ether, furan, trifluoromethane, difluoromethane, difluoroethane, tetrafluoroethane, and heptafluoropropane. The amount of low-boiling compounds homogeneously miscible with cyclopentane and/or with cyclohexane and used in combination with cyclohexane and in particular with cyclopentane is adjusted so that the resultant mixture advantageously has a boiling point below 50° C., preferably from 30 to 0° C. The amount required for this purpose depends on the shape of the boiling-point curves for the mixture, and may be determined experimentally by known methods. Rigid PU foams with low conductivity are obtained in particular when the blowing agent used for each 100 parts by weight of structural component (b) comprises:

The mixture emerging from the mixing apparatus may be transferred into storage vessels. The mixture is preferably drawn off into transport vessels. In another embodiment of the invention, the mixture may be fed directly to the mixing head in which the polyisocyanates are mixed with the compounds having at least two active hydrogen atoms.

In one embodiment of the inventive process, the constituents of the structural polyurethane components, and also the additives, are in each case taken from separate storage tanks and fed to the mixing apparatus, and the finished mixture is continuously removed from the mixing apparatus. This embodiment has the advantage that production of the entire mixture requires only one mixing apparatus. However, if contamination occurs the cleaning cost is relatively high. In addition, this process can result in increased storage cost, if the mixtures are not immediately drawn off into transport vessels, because different additives are frequently added to the structural polyurethane components while the remainder of the composition is identical.

In another embodiment of the inventive process, the additives can be added to one of the starting materials for the structural polyurethane components, and the resultant mixture may be mixed with the other starting materials to give the structural polyurethane components.

In another, preferred embodiment of the inventive process, the structural polyurethane components are first prepared via mixing of their individual constituents, without the additives, then the resultant mixture and the additives are continuously fed to a mixing apparatus, and the resultant mixture is continuously removed from the mixer. The mixing of the individual constituents here to give the structural polyurethane components may take place batchwise, e.g. in stirred tanks, or via continuous mixing of the components, e.g. as described in EP 768 325.

This embodiment has the advantage that structural polyurethane components are produced for inventory and, depending on requirements, the amount needed of additives for the specific intended application may be added. The additives are preferably admixed immediately prior to the draw-off or to the shipping unit. The result is no contamination of the mixing device in which the structural polyurethane components are prepared. If contamination of the mixer for the additives occurs, the product stream from the mixer for the structural polyurethane components can be conducted to another mixer, and the contaminated mixer can be cleaned, without stopping production.

The mixing apparatus used for the inventive process may be operated by omitting individual streams and adding others in order to prepare various products. Here again, the contamination potential of the metered components needs to be considered. A regulator and control unit provides the switching-in and -out of individual streams of material, and maintains the desired ratio of streams of material.

The mixing apparatus used for the inventive process has a very compact structure and is easy to dismantle. This permits rapid and simple cleaning. At the same time, this reduces the burden placed on any mixing tanks used, because certain starting materials generating major cleaning requirements can be metered into the downstream mixing apparatus, by-passing the tank. At the same time, the cleaning of conveying pumps is no longer required, because the additives are fed only downstream of the pumps. In addition, the number of contaminated valves and affected pipeline sections reduces.

Mixing apparatus which may be used are preferably static mixers. These apparatus are well-known to the person skilled in the art. By way of example, EP 0 097 458 describes this type of apparatus for the mixing of liquids.

Static mixers are usually tubular apparatus with fixed internals, these serving to mix the individual streams of materials across the tube cross section. Static mixers may be used in continuous processes for carrying out various fundamental processing operations, such as mixing, exchange of material between two phases, chemical reactions, or heat transfer.

The starting materials are homogenized via a pressure drop generated by means of a pump. It is possible to distinguish two fundamental principles of mixing, depending on the nature of the flow in the static mixer.

In laminar-flow mixers, homogenization takes place via separation and rearrangement of the streams of the individual components. Progressive doubling of the number of layers reduces the layer thicknesses until complete mixing at the macro level has been achieved. Mixing at the micro level via diffusion processes is residence-time-dependent. Laminar-flow mixing operations are carried out in helical mixers or mixers with intersecting ducts. The laminar flow is similar to normal tubular flow with low shear forces and with narrow residence time distribution.

In turbulent-flow mixers, vortices are specifically created with the purpose of homogenizing the individual streams of materials. Mixers with intersecting ducts are suitable for this purpose, as are specific turbulence mixers.

Both types of mixers may be used for the inventive process.

The internals used are generally composed of flow-dividing and -diverting, three-dimensional geometric bodies which result in rearrangement, mixing and recombination of the individual components.

Static mixers are commercially available mixing apparatus and are supplied, by way of example, by Fluitec Georg AG, Neftenbach, Switzerland, for various application sectors.

The inventive process is carried out in a mixing apparatus in which a large number of individual streams can be mixed with one another. The supply to the mixing apparatus may either be direct from a mixing tank or from one or more storage tanks. The principal mass flows, and also one or more critical starting materials, are continuously metered via individual lines to the mixing apparatus, in a prescribed mixing ratio. In parallel, the homogenization of the individual components takes place in the mixing apparatus, and finished mixed product leaves the system, and is pumped directly to the draw-off systems or shipping systems, or into product storage tanks. Depending on the requirement, one or more mixing systems may be constructed in series or parallel, in order to minimize the frequency and the extent of occurrences related to contamination.

The method of operating the mixing apparatus may be such as to permit the preparation of various products by omitting individual streams and adding others. Here again, the contamination potential of the metered additives has to be considered. A regulator and control unit provides the switching-in and -out of individual streams of material, and maintains the desired ratio of streams of material.

The mixing system has a very compact structure and is easy to dismantle. This permits rapid and simple cleaning. At the same time, this reduces the burden placed on the mixing tanks, because certain starting materials generating major cleaning requirements are now fed downstream of the mixing tank and not into the tank. At the same time, the cleaning of conveying pumps is no longer required, because the critical starting materials are introduced only downstream of the pumps. In addition, the number of contaminated valves the length and number of critical starting materials are introduced and the length and number of affected pipeline sections reduces.

The inventive process can admix the additives completely homogeneously over the entire concentration range.

The examples below are intended to provide further description of the invention.

### EXAMPLE 1

Substreams of the following, each amount being based on the finished mixture, were metered into a Fluitec CSE-X® mixing apparatus from separate storage vessels:

| | |
|---|---|
| 89% by weight | of Lupraphen ® 8101 low-branched-content |
| | polyester alcohol from BASF Aktiengesellschaft, |
| 7.5% by weight | of 1,4-butanediol, |
| 3% by weight | of silicone-glycol graft polymer (silicone antifoam), |
| | DOW Corning (fluid) 1248, |
| 0.5% by weight | of the amine catalyst N,N,N,N-tetramethyl- |
| | 1,6-hexanediamine. |

The finished mixture was charged to a transport vessel at the end of the mixer.

The mixture was completely homogeneous.

### EXAMPLE 2

Substreams of the following, the amounts being based on the finished mixture, were metered into a mixing apparatus as in example 1 from separate storage vessels:

| | |
|---|---|
| 85.7% by weight | of Lupraphen ® VP 9182 to bifunctional aliphatic |
| | polyester alcohol from BASF Aktiengesellschaft, |
| 8.2% by weight | of 1,4-butanediol, |
| 3.6% by weight | of Na silicate and Al silicate, 50% strength in castor |
| | oil, |
| 2.5% by weight | of color paste: Isopur ® CO 01945/6311, from ISL. |

The finished mixture was charged to a transport vessel at the end of the mixer.

The mixture was completely homogeneous.

1. A process for the admixture of additives to structural polyurethane components, which comprises continuously feeding the additives, which have been selected from the group comprising blowing agents, flame retardants, catalysts, stabilizers, pigments, and/or dyes, and the structural polyurethane components to a mixing apparatus, and continuously removing the resultant mixture from the mixing apparatus, and comprises using static mixers as mixing apparatus and transferring the mixture into storage vessels.

2. The process according to claim 1, wherein the structural polyurethane components are polyisocyanates and compounds having at least two hydrogen atoms reactive toward isocyanate groups.

3. The process according to claim 1, wherein the additives are all of the starting materials which are present in the reaction mixture during the preparation of polyurethanes in addition to the polyisocyanates and to the compounds having at least two hydrogen atoms reactive toward isocyanate groups.

4. The process according to claim 1, wherein the structural polyurethane components are compounds having at least two reactive hydrogen atoms.

5. The process according to claim 1, wherein the constituents of the structural polyurethane components, and also the additives, are in each case taken from separate storage vessels and fed to the mixing apparatus, and the finished mixture is continuously removed from the mixing apparatus, static mixers being used as mixing assemblies.

6. The process according to claim 1, wherein the structural polyurethane components are first prepared via mixing of their individual constituents, without the additives, this mixture and the additives are continuously fed to a mixing apparatus, and the resultant mixture is continuously removed from the mixer.
